(19) United States
(12) Patent Application Publication
(10) Pub. No.: US 2025/0378428 A1
(43) Pub. Date: Dec. 11, 2025

(54) SYSTEM AND METHOD FOR A MULTI-CLOUD MODULAR PAYMENT SWITCH

(71) Applicant: FinResults, Inc., Fort Lauderdale, FL (US)

(72) Inventors: Vasa Krishnan, West Windsor, NJ (US); Shree Mandadi, San Diego, CA (US)

(21) Appl. No.: 19/230,741

(22) Filed: Jun. 6, 2025

Related U.S. Application Data
(60) Provisional application No. 63/657,372, filed on Jun. 7, 2024.

(51) Int. Cl. G06Q 20/10; G06Q 20/02; G06Q 20/40

(52) U.S. Cl. CPC G06Q 20/108; G06Q 20/401; G06Q 20/027

(57) ABSTRACT

The present disclosure relates to a method for multi-cloud modular payment processing. The method includes receiving, at a payment processing system, a payment processing request. The payment processing system analyzes the payment processing request for transaction requirements. The transaction requirements includes geographic location of the payment request. The payment processing system determines multi-cloud routing based on transaction requirements for directing payment transactions to at least one cloud platform for payment processing. The payment processing system communicate with an external system for verifying payment. The payment processing system sends a payment verified message.

### CROSS-REFERENCE TO RELATED APPLICATION

This application is based upon and claims priority to Provisional Application No. 63/657,372 filed on Jun. 7, 2024, the entire content thereof is incorporated herein by reference in its entirety.

### FIELD OF THE INVENTION

The present invention relates to the field of electronic payment processing systems and cloud-based financial transaction platforms. In particular, the present invention relates to multi-cloud payment processing architectures having distributed components and modular services that provide the capability to handle high-volume transactions, ensure system resilience, and maintain regulatory compliance across diverse geographic regions when processing payments.

### BACKGROUND OF THE INVENTION

Electronic payment processing has become a critical component of the global financial infrastructure. As digital transactions continue to grow in volume and complexity, there is an increasing need for robust, scalable, and flexible payment processing systems.

Current payment processing technologies often rely on centralized architectures or single-cloud deployments. While these systems have served the industry well, they are increasingly challenged by the demands of modern financial ecosystems. Centralized systems can become single points of failure, potentially causing widespread disruptions in service. Single-cloud deployments, while offering some advantages over on-premises solutions, may still face limitations in terms of geographic reach, scalability, and resilience.

The global nature of modern commerce requires payment systems that can operate efficiently across multiple regions, each with its own regulatory requirements and market characteristics. Existing systems often struggle to provide consistent performance and reliability across diverse geographic areas, leading to potential service disparities and compliance challenges.

Additionally, the rapid growth of digital transactions has exposed scalability limitations in many current systems. During peak periods or sudden spikes in transaction volume, these systems may experience performance degradation or even outages, resulting in lost revenue and damaged customer trust.

Furthermore, the evolving regulatory landscape in different countries and regions necessitates payment systems that can quickly adapt to new compliance requirements. Single-cloud or centralized systems may face difficulties in rapidly implementing region-specific changes without affecting their global operations.

There is also a growing need for payment systems that can integrate seamlessly with a wide array of financial services, from traditional banking to emerging fintech solutions. This requires a more modular and interoperable architecture than what is typically found in legacy systems.

Accordingly, there is a need for a modular payment system that overcomes these and other challenges.

### SUMMARY

Examples of the present disclosure provides a system and method for a multi-cloud modular payment switch.

According to a first aspect of the present disclosure, a computer-implemented method for multi-cloud modular payment processing is provided. The method may be implemented on a payment processing platform, having one or more component servers or computers. The method may include receiving a payment processing request.

The method may also include analyzing the payment processing request for transaction requirements. The transaction requirements can include geographic location of the payment request. The method may further include determining multi-cloud routing based on transaction requirements for directing payment transactions to at least one cloud platform for payment processing. The method may in addition include communicating with an external system for verifying payment. The method may also include sending a payment verified message.

According to a second aspect of the present disclosure, a computing device, such as a server, is provided. The computing device may include one or more processors, a non-transitory computer-readable memory storing instructions executable by the one or more processors. The one or more processors may be configured to receive a payment processing request. The one or more processors may also be configured to analyze the payment processing request for transaction requirements. The transaction requirements may include geographic location of the payment request. The one or more processors may further be configured to determine multi-cloud routing based on transaction requirements for directing payment transactions to at least one cloud platform for payment processing. The one or more processors may in addition be configured to communicate with an external system for verifying payment. The one or more processors may also be configured to send a payment verified message.

According to a third aspect of the present disclosure, a non-transitory computer-readable storage medium having stored therein instructions is provided. When the instructions are executed by one or more processors of the apparatus, the instructions may cause the apparatus to perform receive a payment processing request. The instructions may further cause the apparatus to analyze the payment processing request for transaction requirements. The transaction requirements include geographic location of the payment request. The instructions may also cause the apparatus to determine multi-cloud routing based on transaction requirements for directing payment transactions to at least one cloud platform for payment processing. The instructions may in addition cause the apparatus to communicate with an external system for verifying payment. The instructions may also cause the apparatus to send a payment verified message.

These and other aspects and advantages will become apparent to those of ordinary skill in the art by reading the following detailed description, with reference where appropriate to the accompanying drawings. Further, it should be understood that the foregoing summary is merely illustrative and is not intended to limit in any manner the scope or range of equivalents to which the appended claims are lawfully entitled.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram of a payment processing system, according to an example of the present disclosure.

FIG. 2 is a block diagram of a payment processing system architecture, according to an example of the present disclosure.

FIG. 3 is a block diagram of a front end flow of a payment processing system, according to an example of the present disclosure.

FIG. 4 is a flow chart illustrating a method for multi-cloud modular payment processing, according to an example of the present disclosure.

### DETAILED DESCRIPTION

While the present invention is capable of being embodied in various forms, for simplicity and illustrative purposes, the principles of the invention are described by referring to certain embodiments thereof. It is understood, however, that the present disclosure is to be considered as an exemplification of the claimed subject matter and is not intended to limit the appended claims to the specific embodiments illustrated. It will be apparent to one of ordinary skill in the art that the invention may be practiced without limitation to these specific details. In other instances, well-known methods and structures have not been described in detail so as not to unnecessarily obscure the invention. For example, while embodiments herein are described with reference to payment processing, it is understood that the systems and methods may be implemented similarly with respect to various types of financial transactions and data processing more generally.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the terms “and” and “or” used herein is intended to signify and include any or all possible combinations of one or more of the associated listed items. As used herein, the term “if” may be understood to mean “when” or “upon” or “in response to a judgment” depending on the context.

The present disclosure relates to a multi-cloud payment processing system and method. In one or more embodiments, a multi-cloud modular payment switch system can process and route financial transactions across multiple cloud providers simultaneously. In this way, payment processors can securely and reliably process payments across diverse geographic regions with high performance and regulatory compliance, regardless of their location or the payment methods involved. In such embodiments, the system operates as a distributed system across multiple cloud providers, utilizing stateless Application Programming Interfaces (APIs) deployed on computer nodes. When a payment request is received, the switch dynamically routes it through the most appropriate cloud infrastructure based on factors such as geographic proximity, current load, and regulatory requirements. This approach addresses the limitations of traditional centralized or single-cloud payment systems by implementing a distributed payment switch across multiple cloud providers.

The system includes leveraging distributed architecture, dynamic load balancing, unified security, and adaptive regulatory compliance to offer unprecedented reliability, scalability, and global reach in payment processing. The computer nodes, which may be implemented as Kubernetes clusters or similar technologies, create a robust, scalable, and flexible infrastructure for handling global financial transactions. By incorporating unified edge services, cross-cloud database replication, and dynamic inter-cloud routing, the system achieves enhanced reliability, performance, and regulatory compliance. This comprehensive approach enables the payment switch to efficiently manage routing, processing, load balancing, and protocol translation across diverse geographic regions and regulatory landscapes, while maintaining high availability and security. Ultimately, the system's cloud-agnostic scalability and integrated multi-cloud security model represent a significant advancement in payment processing technology, capable of meeting the evolving demands of modern global commerce.

In one or more embodiments, the system infrastructure is broken into three distinct tiers, (1) Web Tier, (2) App Tier, and (3) Data Tier, to implement a robust and scalable multi-cloud architecture. The Web Tier, managed through, for example, Cloudflare, handles Domain Name System (DNS) entries, firewall, and cloud provider registry for processing, focusing on front end authorization and switch functionality. This tier acts as the first point of contact for incoming requests, providing security and load balancing. The App Tier contains three platform architecture zones, Frontend, Backend, and Reporting, utilizing Kubernetes-based stateless API gateway architecture deployed across multiple cloud vendors. This middle tier processes business logic and manages the core functionality of the payment switch. The Data Tier comprises three platform data zones: Frontend, Backend/Reporting, with replicated databases across multi-cloud vendors. This separation into tiers offers several advantages: it allows for independent scaling of each layer, enhances security by isolating sensitive data operations, improves maintainability by separating concerns, and enables efficient distribution of workloads across multiple cloud providers. Additionally, this architecture facilitates better resource allocation, allows for easier updates and modifications to specific components, and provides the flexibility to optimize each tier for its specific role in the payment processing system.

The system's core component is a distributed payment switch implemented across multiple cloud providers such as Amazon Web Services (AWS), Google Cloud, and Azure. This switch, rather than being a single physical entity, is a distributed system of stateless APIs running on computer nodes across various cloud environments.

The switch serves as the central routing and processing hub for payment transactions, handling functions such as routing incoming payment requests, processing core payment tasks (e.g., card validation, risk assessment, transaction authorization), load balancing, and protocol translation. In real-world applications, when a customer initiates a payment, the request first passes through a reverse proxy layer for initial security checks and routing before reaching the payment switch. The switch then authenticates the request, determines the necessary processing, and routes it to appropriate services, which may be on different cloud platforms.

In one or more embodiments, the system incorporates comprehensive protocol translation capabilities to facilitate seamless communication between diverse financial institutions and payment methods. The protocol translation engine can support multiple payment protocols including ISO 8583 for card-based transactions, SWIFT messaging for international wire transfers, ACH (Automated Clearing House) formats for domestic bank transfers, and modern REST/JSON APIs for fintech integrations. When a payment request is received, the system can first identify the source protocol format and the required destination protocol based on the target financial institution or payment processor. The translation process involves parsing the incoming message structure, extracting relevant data fields such as transaction amount, account numbers, merchant identifiers, and timestamp information, then reformatting this data according to the target protocol's specifications. For example, when translating from a REST API request to ISO 8583 format, the system maps JSON fields to specific ISO 8583 data elements, applies proper field lengths and data types, and constructs the binary message structure required by traditional card networks. The protocol translator also handles character encoding conversions, currency code standardization, and time zone adjustments to ensure accurate data representation across different systems.

This multi-cloud architecture offers several advantages over traditional single-cloud or centralized systems. It provides improved resilience against failures, enhanced scalability to handle high transaction volumes, better adaptability to different regulatory environments, and improved connectivity with various financial services. The system employs stateless API design, unified edge services through Cloudflare, cross-cloud database replication, dynamic inter-cloud routing, and cloud-agnostic scalability. It also features integrated multi-cloud security, regulatory compliance flexibility, blue-green deployment capabilities across clouds, and unified monitoring and management.

The system is designed to cater to a wide range of users including payment service providers, large e-commerce platforms, financial institutions, global retailers, fintech companies, cryptocurrency exchanges, multinational corporations, and online marketplaces. By leveraging multiple cloud services and advanced architectural principles, this payment system aims to better handle the challenges of modern global finance and commerce, offering improved performance, reliability, security, and adaptability compared to existing payment infrastructures.

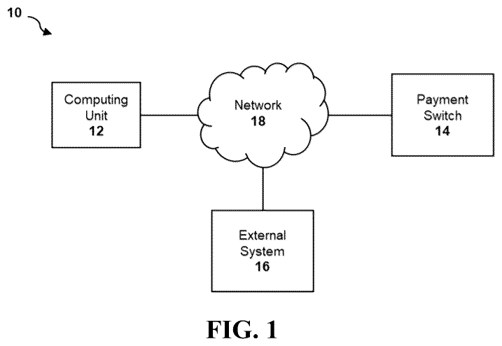

Turning now to the figures, FIG. 1 shows a payment processing system 10. The payment system 10 includes a computing unit 12, payment switch 14, external system 16, and network 18. The payment system 10 is designed to facilitate secure and efficient payment processing across multiple platforms. The payment system 10 includes a computing unit 12, which can be a user's smartphone, tablet, or computer, running a payment application that allows customers to initiate and manage payment transactions. This computing unit 12 communicates over a network 18, which may include the internet and cloud infrastructure, to connect with a payment switch 14. The payment switch 14 serves as the central hub of the system, routing payment requests, managing authentication, and coordinating communication between various components. It interfaces with external systems 16, which may include payment gateways, banking networks, and other financial institutions, to complete the payment process. The payment switch 14 is designed to handle multiple payment methods, currencies, and regulatory requirements, ensuring a versatile and compliant payment ecosystem.

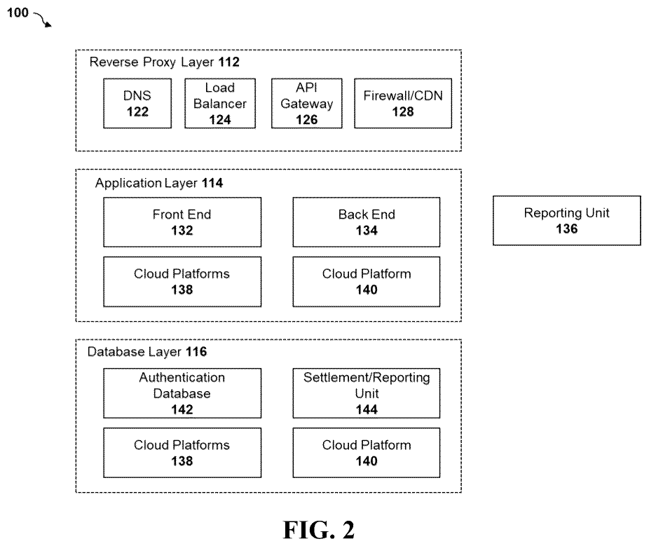

FIG. 2 shows a payment processing infrastructure 100 with a reverse proxy layer 112, application layer 114, and database layer 116. The reverse proxy layer 112 includes a load balancer 120 that comprises a DNS 122, load balancer 124, API Gateway 126, and Firewall/Content Delivery Network (CDN) 128. The Application layer 114 includes a front end 132, back end 134, and reporting 136. The front end 132 incorporates APIs and a switch unit to connect to cloud platforms 138. The backend 134 encompasses settlement processing, batch jobs, spot instances, and onboarding customer support functionalities for connecting to cloud platform 140. The reporting module 136 provides summary reporting, statements, analytics, and ad-hoc reporting capabilities. The database layer 116 consists of an authentication database 142, and can include separate settlement and reporting databases 144. The front end 132 and authentication database 142 are designed to integrate with cloud platforms 138, 140, such as vendors such as Google Cloud Platform, Amazon Web Services (AWS), and Microsoft Azure.

This multi-cloud payment processing infrastructure is designed to provide a scalable, secure, and efficient system for handling financial transactions across various cloud environments. The reverse proxy layer 112 serves as the first point of contact for incoming requests, providing services such as load balancing, DNS resolution, API management, and security through its firewall and content delivery network capabilities. This layer effectively manages and distributes incoming traffic across the system, ensuring optimal performance and security.

The application layer 114 is where processing of payments and related operations occur. The front end 132 handles incoming requests through its APIs and utilizes the switch 140 to route transactions appropriately. The backend 134 manages functions such as settlement processing, which ensures that funds are correctly transferred between parties involved in transactions. It also handles batch jobs for efficient processing of multiple transactions, utilizes spot instances for cost-effective computing resources, and provides customer support and onboarding functionalities. The reporting module 36 generates various types of reports, including summaries, statements, and analytics, which are used for monitoring system performance, transaction tracking, and business intelligence.

The database layer 116 underpins the entire system, storing and managing data. The authentication database 142 is central to maintaining security, storing user credentials and access permissions. Additional databases for settlement and reporting ensure that transaction data and generated reports are securely stored and easily accessible when needed. The integration with major cloud providers like Google Cloud Platform, AWS, and Microsoft Azure allows for a truly distributed and resilient system, capable of leveraging the strengths of each platform while mitigating the risks associated with relying on a single cloud provider.

FIG. 2 illustrates a front end system 200 of the multi-cloud payment processing infrastructure. The system comprises a customer application 210, which allows users to initiate payment processes, connected to a reverse proxy layer 220. This layer includes a DNS 222, load balancer 224, CDN 226, and DDOS protection 228, which collectively manage and secure incoming traffic. The reverse proxy layer 220 routes requests to the application layer 240, which consists of stateless APIs 242, 244, 246 deployed across multiple cloud providers, for example, GCP 242, AWS 244, and Azure 246. These stateless APIs interact with the database layer 260, which includes corresponding databases 262, 264, 266, for example, GCP database 262, AWS database 264, and Azure database 266. The application layer 240 can connect to any of the databases in layer 260, and these databases can communicate with each other, enabling data synchronization and replication across cloud providers. This architecture ensures a scalable, resilient, and flexible payment processing system that leverages the strengths of multiple cloud environments.

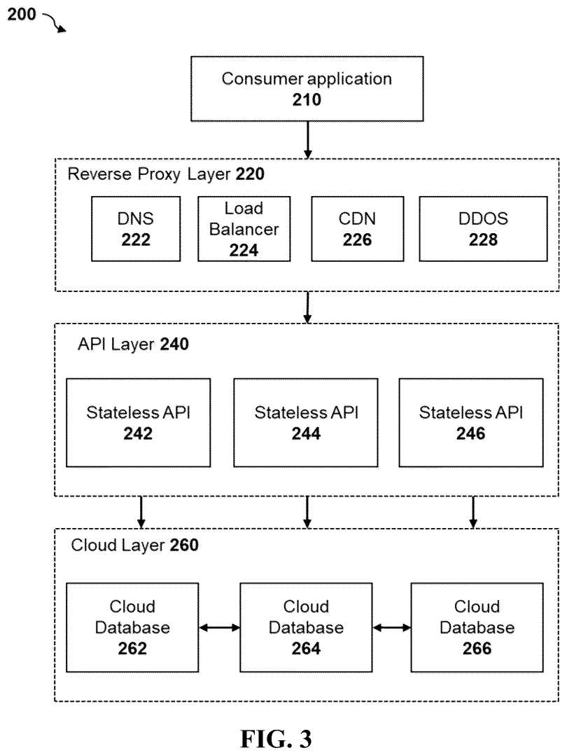

FIG. 3 illustrates a front end system 200 of the multi-cloud payment processing infrastructure. The front end system 200 comprises a customer application 210, a reverse proxy layer 220, an application layer 240, and a database layer 260.

The customer application 210 serves as the primary interface for users to interact with the payment processing system. Customers can initiate payment requests, view transaction histories, and manage their accounts. It could be implemented as a mobile app, web application, or both, ensuring wide accessibility for users across different platforms.

The reverse proxy layer 220 serves as the initial contact point for incoming requests from the customer application, incorporating several components to ensure efficient and secure processing. It includes a DNS (Domain Name System) for resolving domain names to IP addresses and properly routing requests, a load balancer for distributing incoming network traffic across multiple servers to optimize resource utilization and improve response times, a CDN (Content Delivery Network) for efficient delivery of static content to users, reducing latency and enhancing overall performance, and DDOS (Distributed Denial of Service) protection to safeguard against malicious attacks, thereby ensuring system availability and reliability. These components work in concert to provide a robust and responsive front-end infrastructure for the payment processing system.

The application layer 240 employs a multi-cloud strategy, featuring stateless APIs deployed across three major cloud providers: Google Cloud Platform (GCP), Amazon Web Services (AWS), and Microsoft Azure. These stateless APIs are designed to handle requests independently, allowing for improved scalability, fault tolerance, and geographic distribution of processing capabilities. Each cloud provider's API can process payment requests, perform necessary validations, and interact with the respective database instances.

The database layer 260 also leverages a multi-cloud approach, with database instances deployed on GCP, AWS, and Azure. This strategy ensures data redundancy, high availability, and compliance with various regional data regulations. Each database instance stores relevant payment information, user data, and transaction records.

The system's components are interconnected in a hierarchical manner. The customer application 210 connects directly to the reverse proxy layer 220, which then routes requests to the appropriate stateless API in the application layer 240 based on factors such as geographic proximity, current load, or specific routing rules. Each stateless API in the application layer 240 can communicate with any of the database instances in the database layer 260 (GCP, AWS, or Azure), allowing for flexible data access and storage strategies.

Furthermore, the database instances in layer 260 can communicate with each other, enabling data synchronization and replication across cloud providers. This inter-cloud communication ensures data consistency, facilitates disaster recovery processes, and allows for efficient load balancing of database operations.

In an embodiment, a multi-cloud payment processing method includes a user initiating a payment request through the computing unit 12 (e.g., smartphone, tablet, or computer) using a payment application. The payment request is sent over the network 18 (internet and cloud infrastructure) to the payment system. The request is received in a reverse proxy layer for initial security checks and routing. The request reaches the distributed payment switch 14, which could be running on any of the cloud providers (AWS, Google Cloud, or Azure). The payment switch 14 authenticates the request. The switch determines processing for the specific payment request. Based on the processing, the switch routes the request to the appropriate services, which may be distributed across different cloud platforms.

The payment switch 14 employs a sophisticated decision-making process to determine which cloud platform to use for processing a payment request. This process considers multiple factors in real-time, leveraging both current data and predefined rules to make optimal routing choices. The switch evaluates geographic proximity to minimize latency, current load and capacity of each cloud platform to ensure balanced distribution, and specific regulatory requirements that may necessitate processing in certain regions. It also takes into account performance metrics of each cloud provider, choosing the one currently offering the best response times or reliability, as well as cost considerations to potentially route to the most cost-effective option when other factors are equal. Additionally, the type of transaction or specific features may influence the decision, as certain cloud platforms may better support particular functionalities. The switch continuously monitors these factors and uses algorithms to dynamically adjust its routing decisions, ensuring efficient and compliant processing across the multi-cloud infrastructure. This adaptive approach allows the system to optimize resource utilization, maintain performance and reliability, and adhere to varying regulatory landscapes, ultimately providing a more resilient and flexible payment processing solution.

In an embodiment, routing is based on latency and geographic positioning of a customer submitting a payment for processing. However, all transactions are evaluated based on the nearest available cloud services, determined based on latency and not geographical location, and routed to that particular instance. This latency-based routing approach provides several advantages over traditional geographic-based routing methods, including faster transaction processing times and improved system resilience. By prioritizing network latency over physical distance, the system can achieve optimal performance by accounting for real-world network conditions such as traffic congestion and infrastructure quality variations. This intelligent routing ensures consistent performance and seamless failover capability, as transactions can be dynamically redirected to the best-performing cloud instance based on current latency measurements rather than rigid geographic assignments.

In one or more embodiments, the multi-cloud routing system makes intelligent decisions based on comprehensive analysis of transaction requirements through specific real-world scenarios. For example, when processing a high-value domestic wire transfer originating from a customer in New York, the system evaluates compliance with the US banking requirements and routes the transaction to a US-based cloud platform that maintains data residency within US boundaries to ensure compliance with federal banking regulations, while also considering state-specific financial regulations and the other payment processing requirements for domestic transfers. In another example, during peak shopping periods such as Black Friday, when transaction volumes spike dramatically, the routing algorithm detects increased load on the primary cloud platform and automatically distributes overflow traffic to secondary platforms based on current capacity metrics, ensuring sub-second response times are maintained. The routing decisions also account for time-sensitive transactions, such as point-of-sale payments, which are prioritized and routed to the geographically closest cloud platform with the lowest latency to ensure immediate authorization responses.

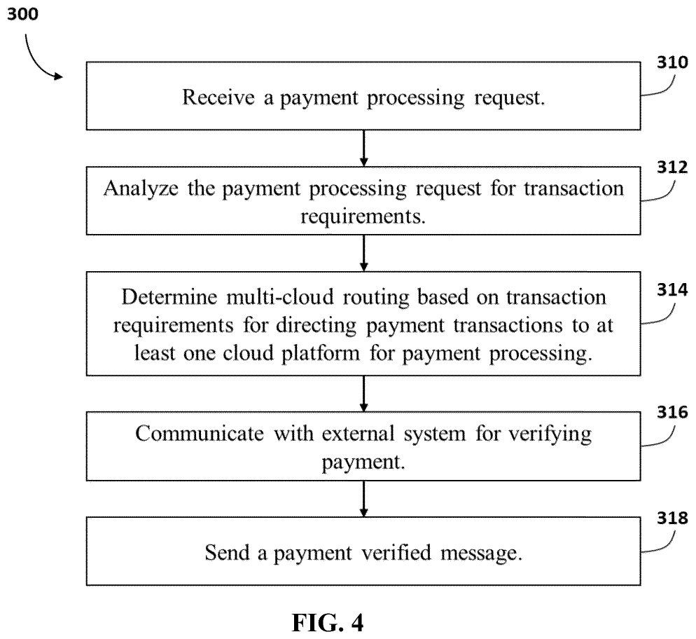

FIG. 4 shows an example method for multi-cloud modular payment processing in accordance with the present disclosure. The method can be applied to a payment switch 14, server, or computer system or platform.

In step 310, the payment switch receives a payment processing request. For example, the request can originate from a customer-facing application or point-of-sale system and contains transaction details such as the payment amount, payment method, and merchant information. Upon receipt, the payment switch begins to parse and validate the incoming request, ensuring fields are present and properly formatted.

In step 312, the payment switch analyzes the payment processing request for transaction requirements. The transaction requirements includes geographic location of the payment request. For example, the switch uses the location data to determine the most appropriate cloud platform for handling the transaction, considering factors such as proximity to the user, regional regulatory compliance requirements, and the performance of different cloud providers in specific geographic areas. For instance, a payment request originating from Europe might be routed to a cloud platform with strong data protection measures to ensure GDPR compliance, while a request from Asia could be directed to a cloud provider with robust infrastructure in that region to minimize latency. By leveraging geographic location in this way, the payment switch can enhance processing speed, reduce costs, and ensure adherence to location-specific regulations and best practices.

The transaction requirements may also include regulatory requirements, performance metrics, and cost considerations for payment request. For example, regulatory requirements are assessed to ensure compliance with region-specific laws and financial regulations, which may vary significantly across different jurisdictions. This could involve routing transactions through specific cloud platforms that meet stringent data protection standards or have necessary certifications for handling sensitive financial information. Similarly, performance metrics are evaluated to select the most efficient processing route, considering factors such as current server load, network latency, and historical performance data of different cloud providers. This helps in maintaining high transaction speeds and minimizing processing delays. Additionally, cost considerations are factored in to balance performance with economic efficiency. The switch may choose between different cloud providers or services based on their pricing structures, taking into account factors like data transfer costs, processing fees, and volume-based discounts.

In step 314, the payment switch determines multi-cloud routing based on transaction requirements for directing payment transactions to at least one cloud platform for payment processing. For example, this step includes analyzing the specific attributes and requirements of each incoming transaction to make intelligent routing decisions. The payment switch evaluates factors such as transaction type, volume, geographic origin, and current system load across multiple cloud platforms. Based on these criteria, it dynamically selects the optimal cloud platform or combination of platforms to handle the transaction processing. This multi-cloud routing strategy ensures efficient load balancing, enhances system resilience, and allows for seamless scaling of processing capacity across different cloud environments as transaction volumes fluctuate.

In one or more embodiments, the system employs sophisticated load balancing algorithms to optimize traffic distribution across multiple cloud platforms. The load balancing mechanism can utilize a combination of weighted round-robin, least connections, and response time-based algorithms to intelligently distribute incoming payment requests. The weighted round-robin algorithm assigns different weights to each cloud platform based on their processing capacity and current performance metrics, ensuring that more powerful or less loaded platforms receive a proportionally higher number of requests. The least connections algorithm monitors the number of active connections to each cloud platform and routes new requests to the platform with the fewest active connections, preventing any single platform from becoming overwhelmed. Additionally, the system implements response time-based load balancing that continuously measures the response times from each cloud platform and dynamically adjusts routing to favor platforms with the fastest response times. The load balancer also incorporates status checks that regularly ping each cloud platform to ensure availability, automatically removing failed or unresponsive platforms from the routing pool and redistributing their traffic to healthy platforms.

In step 316, the payment switch communicates with the external system for verifying payment. For example, this step includes the payment switch interfacing with relevant external financial systems, such as card networks, issuing banks, or other payment processors, to validate and authorize the transaction. The payment switch securely transmits transaction details to these external systems, which may include card information, transaction amount, and merchant details. It then awaits a response from these systems, which typically involves a series of checks including account verification, fraud detection, and available funds confirmation. This communication is used for ensuring the legitimacy and feasibility of the payment before final processing occurs.

In step 318, the payment switch sends a payment verified message. For example, the payment verified message is sent back to the originating customer application, indicating that the transaction has been approved and completed. This message may include details such as the transaction ID, amount processed, and timestamp. The verified message serves as a confirmation to the user that their payment has been successfully processed and accepted by the financial institutions involved. It also triggers any follow-up actions in the customer application, such as updating the user's account balance or generating a receipt for the transaction.

In one or more embodiments, the system handles various types of payment transactions with flexibility and reliability. Examples of how the system handles specific types of payment transactions include processing Sale, Auth, Void, Refund, and Capture transaction types across the multi-cloud infrastructure. Each payment transaction has the capability to be routed to any of the available large-scale cloud computing providers, and the transaction is instantly available on all other clouds, in case the system needs to void this transaction. This cross-cloud synchronization ensures that transaction state is maintained consistently across all platforms, enabling seamless transaction management regardless of which cloud platform initially processes the request.

The system can support multiple transaction types including Sale transactions for immediate payment processing, Auth transactions for payment authorization without immediate capture, Void transactions for canceling previously authorized payments, Refund transactions for returning funds to customers, and Capture transactions for completing previously authorized payments. Each of these transaction types can be processed on any available cloud platform, with transaction data immediately synchronized across all other cloud instances to ensure consistency and enable cross-platform transaction management operations.

In one or more embodiments, the system incorporates comprehensive performance metrics and benchmarks to ensure optimal transaction processing. On each cloud platform, the system includes auto scaling to grow as demand increases, with new instances spun up in, for example, less than 2 minutes and automatically scaled down when demand reduces. This dynamic scaling capability ensures that the system can handle varying transaction volumes efficiently while maintaining cost-effectiveness. All transactions are guaranteed to be processed in seconds, for example, in under 3 seconds, with average processing times of less than 1 second, demonstrating the system's high-performance capabilities across the multi-cloud infrastructure. The auto-scaling capabilities deployed across each cloud platform ensure that processing capacity can rapidly expand to meet increased demand, with new instances becoming available in minutes. This rapid scaling, combined with the system's guarantee of second transaction processing times and average response times of less than 1 second, provides users with consistently fast and reliable payment processing regardless of transaction volume or system load.

In one or more embodiments, the multi-cloud payment processing system and method can be implemented using a robust computing environment designed for high-performance financial transaction processing. This environment consists of a processor unit, memory, and a versatile I/O interface, all working in concert to handle the complex tasks involved in multi-cloud payment routing and processing.

The system's core functionality is driven by the processor unit, which could be one or more high-performance CPUs, GPUs, or a combination of both. This processor executes algorithms that analyze incoming payment requests, determine optimal routing across multiple cloud platforms, and manage communication with external financial systems. The processor unit's ability to handle these computationally intensive tasks with low latency is used for maintaining the system's responsiveness and efficiency.

The memory component plays an important role in supporting the system's operations. It stores a wide range of data, including routing algorithms, transaction histories, and real-time performance metrics of various cloud platforms. The memory utilizes a combination of fast-access SRAM for immediate data retrieval and non-volatile storage like EEPROM or flash memory for persistent data. This memory architecture enables the system to access and process the large volumes of data used for informed decision-making in payment routing.

The I/O interface is used for the system's interaction with external components and cloud platforms. It facilitates high-speed, secure communication between the payment switch and multiple cloud environments, as well as with external financial institutions. The I/O interface is designed to handle high-bandwidth, low-latency communications, often incorporating advanced encryption standards to ensure the security of financial transactions.

The entire system is controlled by a suite of software programs stored in non-volatile memory. These programs implement the core logic of the payment switch, including algorithms for transaction analysis, cloud platform selection, and regulatory compliance checking. The software is designed to be modular and easily updatable, allowing for the addition of new features or support for additional cloud platforms as needed.

In more advanced implementations, the system may incorporate specialized hardware components such as ASICs, FPGAs, or DSPs. These can be programmed to perform specific, computationally intensive tasks related to payment processing, such as real-time fraud detection or encryption/decryption operations. This hardware acceleration can significantly enhance the system's performance and throughput.

By leveraging this powerful and flexible computing environment, the multi-cloud payment processing system can efficiently handle a high volume of transactions with the speed, security, and reliability used in modern financial systems. Its ability to dynamically adapt to changing conditions across multiple cloud platforms represents a significant advancement in payment processing technology.

Thus, the multi-cloud modular payment switch represents a technological improvement over conventional centralized and single-cloud payment processing systems by solving specific technical problems inherent in existing payment infrastructure. Unlike traditional systems that suffer from single points of failure and geographic limitations, the present disclosure provides a concrete technical solution through its distributed architecture that dynamically routes payment transactions across multiple cloud platforms based on real-time analysis of latency, load balancing, and regulatory requirements. The system's stateless API design deployed on computer nodes across different cloud providers creates a robust technical framework that eliminates the bottlenecks and failure vulnerabilities of centralized systems, while the cross-cloud database replication and dynamic inter-cloud routing mechanisms ensure data consistency and system resilience that was previously unattainable. The present disclosure's ability to automatically scale processing capacity across multiple cloud environments within minutes, guarantee mere second transaction processing times, and seamlessly handle protocol translations between diverse financial systems represents a tangible improvement in computer functionality that enhances the reliability, speed, and geographic reach of electronic payment processing. This technical advancement directly addresses the computer-centric problems of system scalability, fault tolerance, and performance optimization in distributed computing environments, providing measurable improvements in transaction throughput, system availability, and processing efficiency.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. In addition, while the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

What is claimed is:

1. A method for multi-cloud modular payment processing, comprising:
receiving a payment processing request;
analyzing the payment processing request for transaction requirements, wherein the transaction requirements comprise geographic location of the payment request;
determining multi-cloud routing based on transaction requirements for directing payment transactions to at least one cloud platform for payment processing;
communicating with an external system for verifying payment; and
sending a payment verified message.

2. The method of claim 1, wherein the transaction requirements comprise regulatory requirements, performance metrics, and cost considerations for the payment processing request.

3. The method of claim 1, further comprising
directing the payment processing request to relevant services within the at least one cloud platform, wherein the relevant services are hosted in different cloud platforms.

4. The method of claim 1, further comprising
managing the payment processing request, wherein payment processing request includes validating a card and authorizing a transaction.

5. The method of claim 1, further comprising
converting a payment protocol translation for facilitating communication between financial institutions or payment methods.

6. The method of claim 1, further comprising
performing load balancing for distributing traffic efficiently across multiple instances and cloud providers.

7. The method of claim 1, further comprising:
determining a current load of an available cloud platform.

8. A computing device comprising:
one or more processors;
a non-transitory computer-readable storage medium storing instructions executable by the one or more processors, wherein the one or more processors are configured to:
receive a payment processing request;
analyze the payment processing request for transaction requirements, wherein the transaction requirements comprise geographic location of the payment processing request;
determine multi-cloud routing based on transaction requirements for directing payment transactions to at least one cloud platform for payment processing;
communicate with an external system for verifying payment; and
send a payment verified message.

9. The computing device of claim 8, wherein the transaction requirements comprise regulatory requirements, performance metrics, and cost considerations for the payment processing request.

10. The computing device of claim 8, wherein the one or more processors are further configured to
direct the payment processing request to relevant services within the at least one cloud platform, wherein the relevant services are hosted in different cloud platforms.

11. The computing device of claim 8, wherein the one or more processors are further configured to
manage the payment processing request, wherein managing the payment processing request includes card validation and transaction authorization.

12. The computing device of claim 8, wherein the one or more processors are further configured to
convert a payment protocol translation for facilitating communication between financial institutions or payment methods.

13. The computing device of claim 8, wherein the one or more processors are further configured to
perform load balancing for distributing traffic efficiently across multiple instances and cloud providers.

14. The computing device of claim 8, wherein the one or more processors are further configured to
determine a current load of an available cloud platform.

15. A non-transitory computer-readable storage medium storing a plurality of programs for execution by a computing device having one or more processors, wherein the plurality of programs, when executed by the one or more processors, cause the computing device to:
receive a payment processing request;
analyze the payment processing request for transaction requirements, wherein the transaction requirements comprise geographic location of the payment processing request;
determine multi-cloud routing based on transaction requirements for directing payment transactions to at least one cloud platform for payment processing;
communicate with an external system for verifying payment; and
send a payment verified message.

16. The non-transitory computer-readable storage medium of claim 15, wherein the transaction requirements comprise regulatory requirements, performance metrics, and cost considerations for the payment processing request.

17. The non-transitory computer-readable storage medium of claim 15, wherein the plurality of programs further cause the computing device to
direct the payment processing request to relevant services within the at least one cloud platform, wherein the relevant services are hosted in different cloud platforms.

18. The non-transitory computer-readable storage medium of claim 15, wherein the plurality of programs further cause the computing device to manage the payment processing request, wherein payment processing request includes validating a card and authorizing a transaction.

19. The non-transitory computer-readable storage medium of claim 15, wherein the plurality of programs further cause the computing device to
convert a payment protocol translation for facilitating communication between financial institutions or payment methods.

20. The non-transitory computer-readable storage medium of claim 15, wherein the plurality of programs further cause the computing device to
perform load balancing for distributing traffic efficiently across multiple instances and cloud providers.
